(19) United States
(12) Patent Application Publication
(10) Pub. No.: US 2012/0136528 A1
(43) Pub. Date: May 31, 2012

(54) APPARATUS FOR EMERGENCY DRIVING OF VEHICLE AND METHOD THEREOF

(75) Inventors: Sejun KIM, Seoul (KR); Chongah Gwon, Hwaseong-si (KR); Jiyong Yu, Pocheon-si (KR); Junghwan Bang, Hwaseong-si (KR)

(73) Assignee: Hyundai Motor Company, Seoul (KR)

(21) Appl. No.: 13/212,059

(22) Filed: Aug. 17, 2011

(30) Foreign Application Priority Data
Nov. 30, 2010 (KR) 10-2010-0120830

(51) Int. Cl. B60K 28/10

(52) U.S. Cl. 701/31.9; 701/33.6

(57) ABSTRACT

An apparatus for emergency driving of a vehicle includes an engine fail recognizing unit monitoring an operational state of an engine in real time and outputting an engine fail recognition signal when a failure of the engine is recognized; an emergency driving switch operation recognizing unit recognizing an operation of an emergency driving switch disposed in the vehicle and outputting an emergency driving switch operation signal; an emergency driving condition verifying unit verifying whether emergency driving of the vehicle is possible by comparing predetermined registered emergency drivable condition information with a current state of the vehicle when any one of the engine fail recognition signal and the emergency driving switch operation signal is inputted; and a driving unit forcibly driving the engine of the vehicle by driving a belt driven or other suitable starter according to a verification result of the emergency driving condition verifying unit.

### CROSS-REFERENCE TO RELATED APPLICATIONS

The present application claims priority to Korean Patent Application Number 10-2010-0120830 filed Nov. 30, 2010, the entire contents of which application is incorporated herein for all purposes by this reference.

### BACKGROUND OF INVENTION

1. Field of Invention

The present invention relates to an apparatus for emergency driving of a vehicle and a method thereof, and more particularly, to an apparatus for emergency driving of a vehicle and a method thereof capable of solving emergency situations by forcibly driving an engine of the corresponding vehicle by using a belt-type starter at the time when an engine fails or an emergency driving switch is operated.

2. Description of Related Art

With the introduction of an ISO system, a lot of efforts to improve NVH characteristics of a mechanical starter (a gear mesh type) used in the prior art had been made, and as a result, not the mechanical mesh type but a belt type driving system has been introduced.

The belt type starter system is mounted with ‘a starter generator’ that can be both generated and driven at the position of the existing alternator and uses a method of starting an engine with a belt.

The existing mechanical starter system uses the mechanical mesh type, such that it cannot be driven at predetermined rpm or more and cannot mesh/remove the starter while operating the engine. Further, when the existing mechanical starter system fails in the engine, it does not have an additional method capable of driving a vehicle except for traction.

Accordingly, when the mechanical starter system has a problem in engine, it requires a lot of persons even in order to move the vehicle to a safe position in a short distance.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an apparatus for emergency driving of a vehicle and a method thereof capable of solving emergency situations by forcibly driving an engine of the corresponding vehicle by using a belt driven or other starter at the time when the engine fails or an emergency driving switch is operated.

Various aspects of the present invention provide for an apparatus for emergency driving of a vehicle, comprising an engine fail recognizing unit monitoring an operational state of an engine in real time and outputting an engine fail recognition signal when a failure of the engine is recognized, an emergency driving switch operation recognizing unit recognizing an operation of an emergency driving switch disposed in the vehicle and outputting an emergency driving switch operation signal, an emergency driving condition verifying unit verifying whether emergency driving of the vehicle is possible by comparing predetermined registered emergency drivable condition information with a current state of the vehicle when any one of the engine fail recognition signal and the emergency driving switch operation signal is inputted, and a driving unit forcibly driving the engine of the vehicle by driving a belt driven or other starter according to a verification result of the emergency driving condition verifying unit.

The emergency driving condition verifying unit may verify emergency drivable condition information corresponding to the inputted signal when the emergency drivable condition information in the case where the engine failure is recognized by the engine fail recognizing unit is different from that in the case where the emergency driving switch is operated.

The driving unit may shift a transmission of the vehicle to a D stage before driving the belt driven or other starter when the vehicle is an automatic transmission vehicle.

The apparatus may further include an emergency drivable distance calculating unit calculating an emergency drivable distance according to the current state of the vehicle when it is verified that the emergency driving is possible through the emergency driving condition verifying unit.

The apparatus may further include an output unit outputting the emergency drivable distance information calculated by the emergency drivable distance calculating unit.

The output unit may output information indicating an emergency undrivable state when it is verified that the emergency driving is impossible through the emergency driving condition verifying unit.

Other aspects of the present invention provides for a method for emergency driving of a vehicle, the method including monitoring an operational state of an engine in real time and outputting an engine fail recognition signal when a failure of the engine is recognized, recognizing an operation of an emergency driving switch disposed in the vehicle and outputting an emergency driving switch operation signal, verifying whether emergency driving of the vehicle is possible by comparing predetermined registered emergency drivable condition information with a current state of the vehicle when any one of the engine fail recognition signal and the emergency driving switch operation signal is inputted, and forcibly driving the engine of the vehicle by driving a belt driven or other starter when it is verified that the emergency driving is possible as a verification result of the verifying whether the emergency driving is possible.

In the verifying whether the emergency driving is possible, emergency drivable condition information corresponding to the inputted signal may be verified when the emergency drivable condition information in the case where the engine failure is recognized is different from that in the case where the emergency driving switch is operated.

The driving engine may include shifting a transmission of the vehicle to a D stage before driving the belt driven or other starter when the vehicle is an automatic transmission vehicle.

The method may further include calculating an emergency drivable distance according to the current state of the vehicle when it is verified that the emergency driving is possible as a verification result of the verifying whether the emergency driving is possible.

The method may further include outputting the emergency drivable distance information calculated in the calculating.

The method may further include outputting information indicating an emergency undrivable state when it is verified that the emergency driving is impossible as a verification result of the verifying whether the emergency driving is possible.

According to various aspects of the present invention, it is possible to solve emergency situations by forcibly driving an engine of a corresponding vehicle by using a belt driven or other starter at the time when the engine fails or an emergency driving switch is operated.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram referenced to describe a configuration of an exemplary apparatus for emergency driving of a vehicle according to the present invention.

FIG. 2 is a flowchart showing an operational flow associated with an exemplary method for emergency driving of a vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

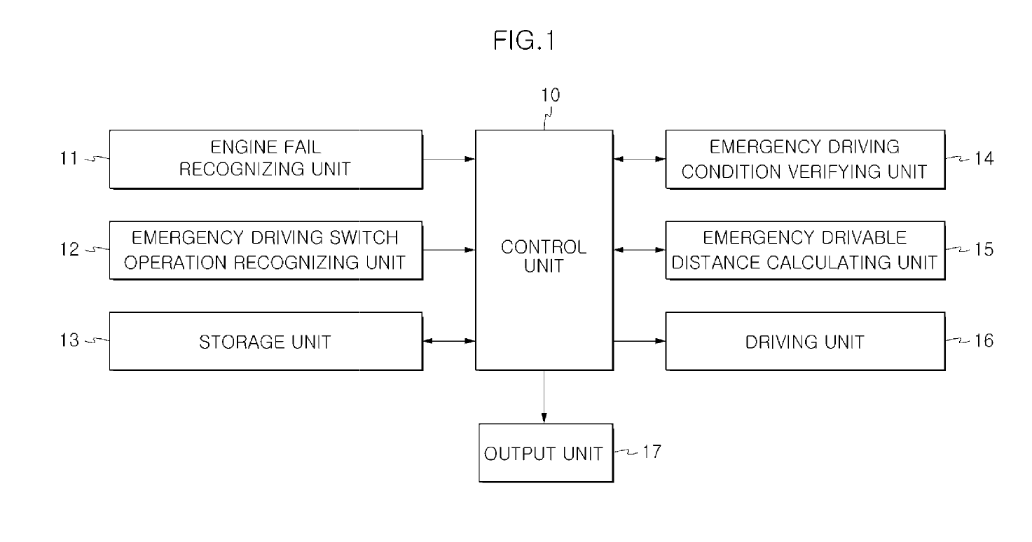

Referring to FIG. 1, the apparatus for emergency driving of a vehicle (hereinafter, referred to as ‘an emergency driving apparatus’) according to various embodiments of the present invention includes a control unit 10, an engine fail recognizing unit 11, an emergency driving switch operation recognizing unit 12, a storage unit 13, an emergency driving condition verifying unit 14, an emergency drivable distance calculating unit 15, a driving unit 16, and an output unit 17. In this case, control unit 10 controls an operation of each of the components of the emergency driving apparatus.

Engine fail recognizing unit 11 monitors an operational state of an engine in real time and recognizes an engine failure immediately when the engine fails (a problem such as a failure occurs). Herein, engine fail recognizing unit 11 may be easily implemented by loading a logic capable of recognizing the failure of the engine on the existing vehicle driving system. Further, when engine fail recognizing unit 11 recognizes the engine fail, it outputs an engine fail recognition signal to control unit 10.

Emergency driving switch operation recognizing unit 12 recognizes whether an emergency driving switch disposed in the vehicle is operated. In this case, the emergency driving switch may be manually operated by a driver when emergency situations occur.

When the emergency driving switch is operated by the driver in the case where engine fail recognizing unit 11 cannot recognize the engine failure though the engine fails, emergency driving switch operation recognizing unit 12 recognizes the operation and outputs an emergency driving switch operation signal to control unit 10.

Storage unit 13 stores condition information in which the corresponding vehicle can be driven in an emergency. Herein, the emergency drivable condition information includes driving condition information associated with a battery, a belt slip, and the like of a belt driving system.

In this case, the emergency drivable condition information in the case where the engine failure is recognized by engine fail recognizing unit 11 may be different from that in the case where the emergency driving switch is operated and if both condition information are different from each other, the emergency drivable condition information may be separately stored in storage unit 13.

When control unit 10 receives the engine fail recognition signal from engine fail recognizing unit 11 or the emergency driving switch operation signal from the emergency driving switch operation recognizing unit 12, it outputs a control signal to emergency driving condition verifying unit 14.

Emergency driving condition verifying unit 14 verifies whether emergency driving is possible according to the control signal inputted from control unit 10. In this case, emergency driving condition verifying unit 14 compares the emergency drivable condition information stored in storage unit 13 with current state information of the vehicle to verify whether the current state information of the vehicle satisfies the emergency drivable condition information. Emergency driving condition verifying unit 14 outputs a comparison result of the current state information of the vehicle and the emergency drivable condition information to control unit 10.

If the emergency drivable condition information in the case where the engine failure is recognized by engine fail recognizing unit 11 is different from that in the case where the emergency driving switch is operated, emergency driving condition verifying unit 14 verifies the emergency drivable condition information for each case.

In other words, emergency driving condition verifying unit 14 verifies the emergency drivable condition information defined for the case where the engine failure is recognized by engine fail recognizing unit 11 when receiving the control signal by the engine fail recognition signal from control unit 10.

Emergency driving condition verifying unit 14 verifies the emergency drivable condition information defined for the case where the emergency driving switch is operated when receiving the control signal by the emergency driving switch operation signal from control unit 10.

Control unit 10 outputs the control signal to emergency drivable distance calculating unit 15 when emergency driving condition verifying unit 14 verifies that the emergency driving is possible.

Emergency drivable distance calculating unit 15 calculates a drivable distance while emergency driving according to a current state of the vehicle and outputs a calculation result to control unit 10. Herein, the emergency drivable distance in the case where the engine failure is recognized by engine fail recognizing unit 11 may be different from that in the case where the emergency driving switch is operated.

In this case, control unit 10 allows the calculation result of emergency drivable distance calculating unit 15 to be outputted through output unit 17. Herein, output unit 17 may include a display member and a voice outputting member. Accordingly, the driver verifies the emergency drivable distance information outputted through output unit 17 to deal with the emergency situations.

Further, control unit 10 outputs the control signal to driving unit 16 when emergency driving condition verifying unit 14 verifies that the emergency driving is possible.

Driving unit 16 drives a belt driven or other suitable starter of a belt driving system according to the control signal from control unit 10. In this case, as the belt-type starter is driven, the engine of the corresponding vehicle can be forcibly driven.

Herein, in the case where the corresponding vehicle is an automatic transmission vehicle, driving unit 16 forcibly shifts a transmission to a D stage and thereafter, drives the belt-type starter so as to transmit motive power of the belt-type starter to a wheel.

Accordingly, the emergency driving apparatus according to various embodiments of the present invention moves the corresponding vehicle to a safe zone by forcibly driving the engine for a predetermined time even when the engine of the vehicle fails to deal with the emergency situations.

Control unit 10 generates information indicating an emergency undrivable state and outputs the information to output unit 17 when emergency driving condition verifying unit 14 verifies that the emergency driving is impossible. In this case, output unit 17 outputs the information indicating the emergency undrivable state through at least one of the display member and the voice outputting member when receiving the information indicating the emergency undrivable state from control unit 10.

An operational flow of various embodiments of the present invention configured as above will be described below.

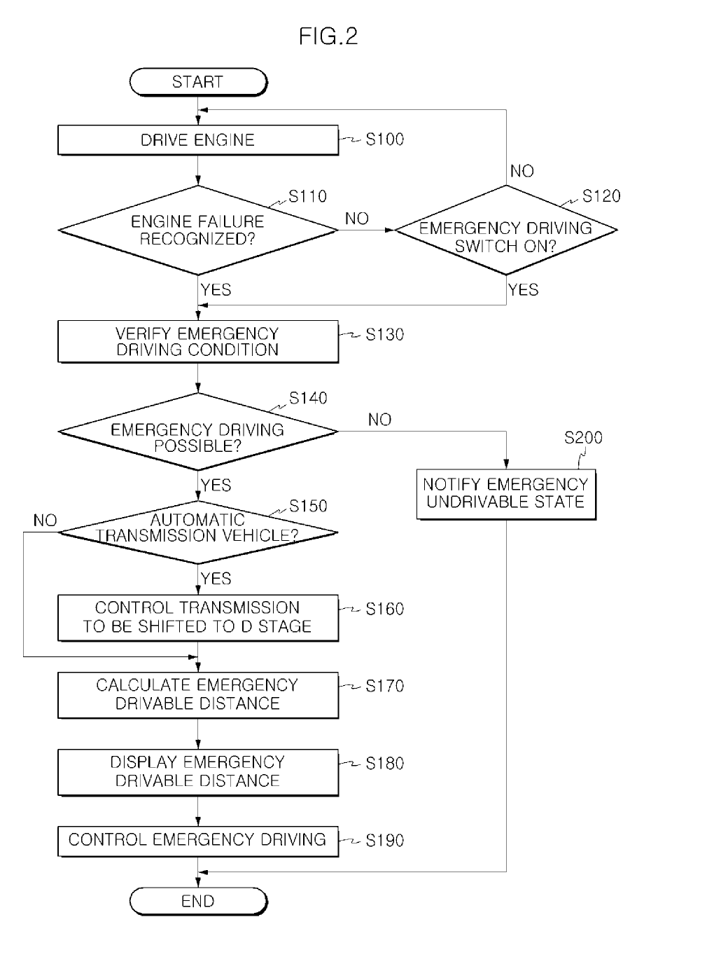

Referring to FIG. 2, the emergency driving apparatus according to various embodiments of the present invention monitors an operational state of the engine and recognizes the engine failure immediately when the engine fails (the problem such as the failure occurs). Further, the emergency driving apparatus monitors whether the emergency driving switch is operated by the driver and recognizes the operation immediately when the emergency driving switch is operated.

If the engine failure is recognized (S110) or an ON operation of the emergency driving switch is recognized (S120) while the engine is driven (S100), the emergency driving apparatus verifies a predetermined stored emergency driving condition and a current state of the vehicle (S130).

Herein, the emergency drivable condition information in the case where the engine failure is recognized by engine fail recognizing unit 11 may be different from that in the case where the emergency driving switch is operated.

Accordingly, when the emergency drivable condition information in the case where the engine failure is recognized by engine fail recognizing unit 11 is different from that in the case where the emergency driving switch is operated, the emergency driving apparatus verifies the emergency drivable condition information corresponding to each of the recognition of the engine failure and the recognition of the ON operation of the emergency driving switch.

In this case, when the emergency driving is impossible because the current state of the vehicle does not satisfy the emergency driving condition (S140), the emergency driving apparatus notifies the emergency undrivable state to the driver through an output screen or a speaker (S200).

In contrast, when the emergency driving is possible because the current state of the vehicle satisfies the emergency driving condition (S140), the emergency driving apparatus performs an emergency driving controlling operation.

In this case, before performing the emergency driving controlling operation, when the corresponding vehicle is the automatic transmission vehicle (S150), the emergency driving apparatus controls the transmission to be shifted to the D stage so as to transmit the motive power of the belt-type starter to the wheel (S160).

Further, the emergency driving apparatus calculates a movable distance while emergency driving according to the current state of the vehicle (S170) and displays the calculated emergency drivable distance through the output screen (S180).

If the output screen is not provided in the vehicle, the calculated emergency drivable distance may be outputted in voice through the speaker. Herein, an output form of the emergency drivable distance information is not limited to any one and may be apparently outputted through output members of different forms which can be recognized by the driver.

Herein, the emergency drivable distance in the case where the engine failure is recognized may be different from that in the case where the emergency driving switch is operated.

Thereafter, the emergency driving apparatus drives the belt-type starter of the belt driving system to perform the emergency driving controlling operation (S190). In this case, as the belt-type starter is driven, the engine of the corresponding vehicle can be forcibly driven.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for emergency driving of a vehicle, comprising:
an engine fail recognizing unit monitoring an operational state of an engine in real time and outputting an engine fail recognition signal when a failure of the engine is recognized;
an emergency driving switch operation recognizing unit recognizing an operation of an emergency driving switch disposed in the vehicle and outputting an emergency driving switch operation signal;
an emergency driving condition verifying unit verifying whether emergency driving of the vehicle is possible by comparing predetermined registered emergency drivable condition information with a current state of the vehicle when any one of the engine fail recognition signal and the emergency driving switch operation signal is inputted; and
a driving unit forcibly driving the engine of the vehicle by driving a starter according to a verification result of the emergency driving condition verifying unit.

2. The apparatus as defined in claim 1, wherein the emergency driving condition verifying unit verifies emergency drivable condition information corresponding to the inputted signal when the emergency drivable condition information in the case where the engine failure is recognized by the engine fail recognizing unit is different from that in the case where the emergency driving switch is operated.

3. The apparatus as defined in claim 1, wherein the driving unit shifts a transmission of the vehicle to a D stage before driving the starter when the vehicle is an automatic transmission vehicle.

4. The apparatus as defined in claim 1, further comprising an emergency drivable distance calculating unit calculating an emergency drivable distance according to the current state of the vehicle when it is verified that the emergency driving is possible through the emergency driving condition verifying unit.

5. The apparatus as defined in claim 1, further comprising an output unit outputting the emergency drivable distance information calculated by the emergency drivable distance calculating unit.

6. The apparatus as defined in claim 5, wherein the output unit outputs information indicating an emergency undrivable state when it is verified that the emergency driving is impossible through the emergency driving condition verifying unit.

7. A method for emergency driving of a vehicle, comprising the steps of:
monitoring an operational state of an engine in real time and outputting an engine fail recognition signal when a failure of the engine is recognized;
recognizing an operation of an emergency driving switch disposed in the vehicle and outputting an emergency driving switch operation signal;
verifying whether emergency driving of the vehicle is possible by comparing predetermined registered emergency drivable condition information with a current state of the vehicle when any one of the engine fail recognition signal and the emergency driving switch operation signal is inputted; and
forcibly driving the engine of the vehicle by driving a starter when it is verified that the emergency driving is possible as a verification result of the verifying whether the emergency driving is possible.

8. The method as defined in claim 7, wherein in the verifying whether the emergency driving is possible, emergency drivable condition information corresponding to the inputted signal is verified when the emergency drivable condition information in the case where the engine failure is recognized is different from that in the case where the emergency driving switch is operated.

9. The method as defined in claim 7, wherein the driving the engine includes shifting a transmission of the vehicle to a D stage before driving the starter when the vehicle is an automatic transmission vehicle.

10. The method as defined in claim 7, further comprising calculating an emergency drivable distance according to the current state of the vehicle when it is verified that the emergency driving is possible as a verification result of the verifying whether the emergency driving is possible.

11. The method as defined in claim 7, further comprising outputting the emergency drivable distance information calculated in the calculating.

12. The method as defined in claim 7, further comprising outputting information indicating an emergency undrivable state when it is verified that the emergency driving is impossible as a verification result of the verifying whether the emergency driving is possible.

13. The method as defined in claim 7, wherein the starter is a belt-driven starter.

14. The apparatus as defined in claim 1, wherein the starter is a belt driven starter.

15. A hybrid vehicle including the apparatus for emergency driving according to claim 1.

16. A hybrid vehicle including the method for emergency driving according to claim 1.
